(19) United States
(12) Patent Application Publication
(10) Pub. No.: US 2014/0045091 A1
(43) Pub. Date: Feb. 13, 2014

(54) FUEL CELL AND METHOD OF MANUFACTURING THE SAME

(71) Applicant: SAMSUNG ELECTRO-MECHANICS CO., LTD., Suwon (KR)

(72) Inventors: Kyong Bok Min, Suwon (KR); Bon Seok Koo, Suwon (KR)

(73) Assignee: SAMSUNG ELECTRO-MECHANICS CO., LTD., Suwon (KR)

(21) Appl. No.: 13/757,555

(22) Filed: Feb. 1, 2013

(30) Foreign Application Priority Data
Aug. 9, 2012 (KR) 10-2012-0087392

(51) Int. Cl. H01M 8/24

(52) U.S. Cl. CPC H01M 8/2465
USPC 429/465

(57) ABSTRACT

Disclosed herein are a fuel cell and a method of manufacturing the same, the fuel cell including a support having a corrugated surface and containing a metal, an integrated stack adhered to the surface of the support and including an anode and an electrolyte sequentially formed therein, and a cathode formed on the integrated stack. According to the present invention, since the anode, the electrolyte, and the like, are manufactured in a sheet shape to thereby be adhered to the support, a sintering process may be minimized, such that a manufacturing process may be simplified and manufacturing cost may be reduced.

### CROSS REFERENCE TO RELATED APPLICATION

This application claims the benefit of Korean Patent Application No. 10-2012-0087392, filed on Aug. 9, 2012, entitled “Fuel Cell and Method of Manufacturing the Same”, which is hereby incorporated by reference in its entirety into this application.

### BACKGROUND OF THE INVENTION

1. Technical Field

The present invention relates to a fuel cell and a method of manufacturing the same.

2. Description of the Related Art

A fuel cell is a device directly converting chemical energy of fuel (hydrogen, liquefied natural gas (LNG), liquefied petroleum gas (LPG), or the like) and oxygen (air) into electrical and thermal energy by an electrochemical reaction. The existing power generation technologies should perform processes such as fuel combustion, steam generation, turbine driving, generator driving, or the like, while the fuel cell does not need to perform processes such as fuel combustion, turbine driving, or the like. As a result, the fuel cell is a new power generation technology capable of increasing power generation efficiency without causing environmental problems. The fuel cell minimally discharges air pollutants such as SO_{X}, NO_{X}, or the like, and generates less carbon dioxide, such that chemical-free, low-noise, non-vibration power generation, or the like, may be implemented.

There are various types of fuel cells such as a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC), or the like. Among them, the solid oxide fuel cell (SOFC) depends on activation polarization, which lowers over-voltage and irreversible loss to increase power generation efficiency. Further, since the reaction rate in electrodes is rapid, the SOFC does not need expensive precious metals as an electrode catalyst. Therefore, the solid oxide fuel cell is an essential power generation technology in order to entry a hydrogen economy society in the future.

FIG. 8 is a conceptual diagram showing a power generation principle of a solid oxide fuel cell. Reviewing a basic power generation principle of a solid oxide fuel cell (SOFC) with reference to FIG. 8, when fuel is hydrogen (H₂) or carbon monoxide (CO), the following electrode reaction is performed in an anode 1 and a cathode 2.

Anode: CO+H₂O→H₂+CO₂

2H₂+2O²⁻→4e⁻+2H₂O

Cathode: O₂+4e⁻→2O²⁻

Entire Reaction: H₂+CO+O₂→CO₂+H₂O

That is, electrons (e⁻) generated in the anode 1 are transferred to the cathode 2 through an external circuit 4 and at the same time, oxygen ions (O²⁻) generated in the cathode 2 are transferred to the anode 1 through an electrolyte 3. In addition, hydrogen (H₂) is combined with oxygen ion (O²⁻) to generate electrons (e⁻) and water (H₂O) in the anode 1. As a result, reviewing the entire reaction of the solid oxide fuel cell, hydrogen (H₂) or carbon monoxide (CO) are supplied to the anode 1 and oxygen is supplied to the cathode 2, such that carbon dioxide (CO₂) and water (H₂O) are generated.

Meanwhile, in the solid oxide fuel cell according to the prior art, the anode, the electrolyte, and the cathode are sequentially stacked on a support as described in Patent Document of the following prior art document. However, in the solid oxide fuel cell according to the prior art, since the anode, the electrolyte, and the cathode are formed using wet coating, viscosity is significantly low, such that the anode, the electrolyte, and the cathode may not be coated and sintered, at a time. Therefore, each of the anode, the electrolyte, and the cathode should be coated and sintered. As described above, since in the solid oxide fuel cell, each of the anode, the electrolyte, and the cathode should be coated and sintered to thereby be manufactured, a manufacturing process may be complicated and manufacturing cost may be excessively consumed. In addition, since sintering is performed several times in the solid oxide fuel cell according to the prior art, secondary phases, which is a kind of insulator, are generated at interfaces of the anode, the electrolyte, and the cathode by chemical reactions. Further, when ceramics (the anode, the electrolyte, the cathode, and the like) and a metal support are co-sintered, since the metal support is oxidized to reduce electrical conductivity, performance of the fuel cell may be deteriorated.

### PRIOR ART DOCUMENT

### Patent Document

(Patent Document 1) US20110008712 A1

### SUMMARY OF THE INVENTION

The present invention has been made in an effort to provide a fuel cell capable of minimizing a sintering process by manufacturing an anode, an electrolyte, and the like, in a sheet shape to be adhered to a support, and a method of manufacturing the same.

According to a preferred embodiment of the present invention, there is provided a fuel cell including: a support having a corrugated surface and containing a metal; an integrated stack adhered to the surface of the support and including an anode and an electrolyte sequentially formed therein; and a cathode formed on the integrated stack.

The integrated stack may further include a prevention film formed on the electrolyte.

The support and the integrated stack may be adhered to each other using a chemical binder.

The support may be made of porous metal foam or a metal having a mesh structure.

The anode and the electrolyte may be manufactured in a sheet shape by a tape casting method.

The cathode may be formed by a spray coating method or a screen printing method.

The prevention film may be manufactured in a sheet shape by a tape casting method.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a fuel cell according to a preferred embodiment of the present invention;

FIGS. 2 to 7 are cross-sectional views showing a method of manufacturing the fuel cell according to the preferred embodiment of the present invention in a process sequence; and

FIG. 8 is a conceptual diagram showing a power generation principle of a solid oxide fuel cell.

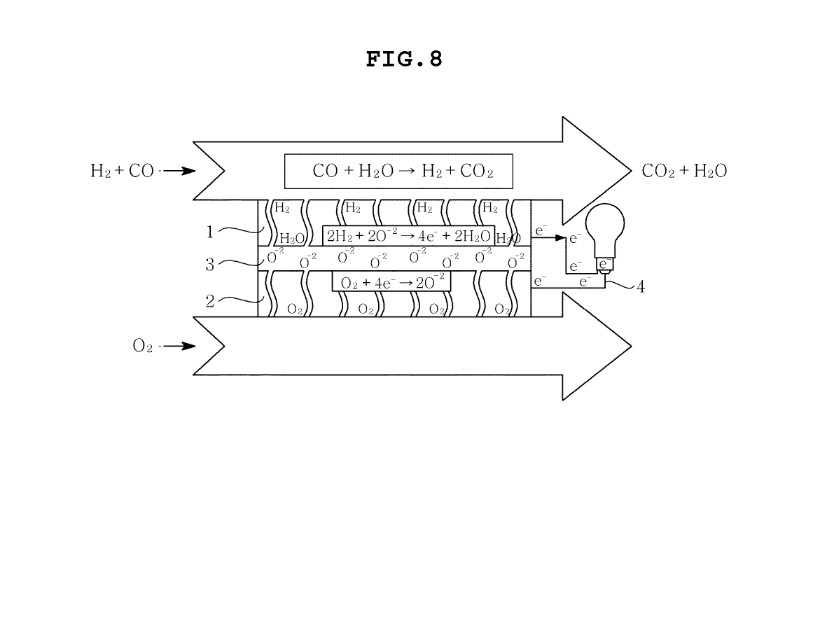

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

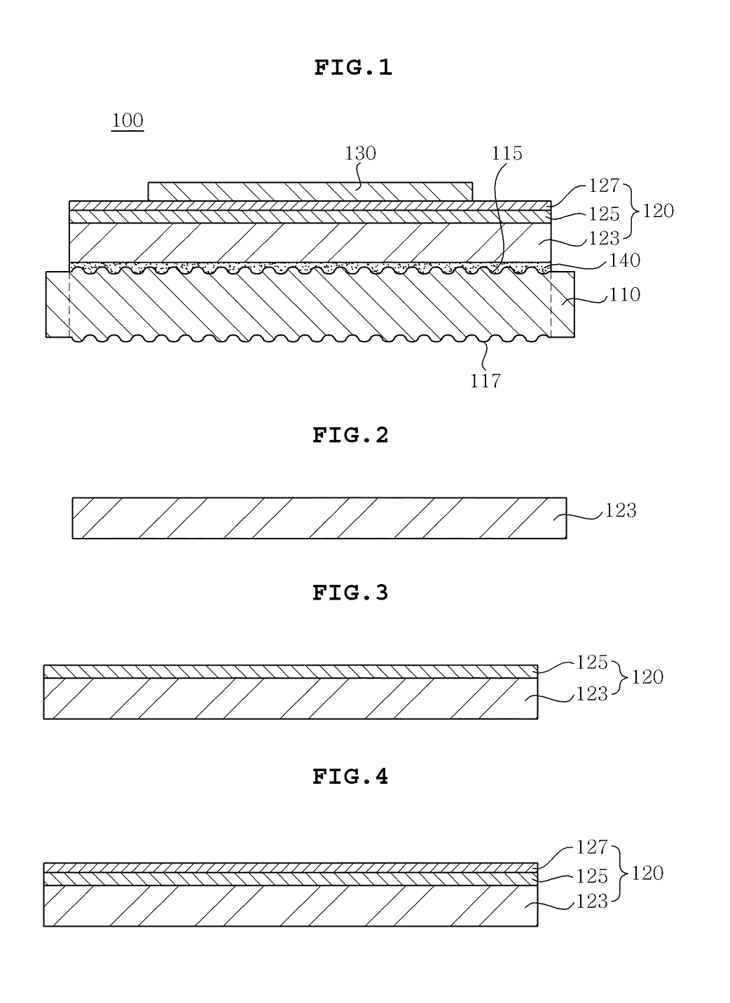

FIG. 1 is a cross-sectional view of a fuel cell according to a preferred embodiment of the present invention.

As shown in FIG. 1, the fuel cell 100 according to the preferred embodiment of the present invention may be configured to include a support 110 having a corrugated surface 115 and containing a metal, an integrated stack 120 adhered to the surface 115 of the support 110 and including an anode 123 and an electrolyte 125 sequentially formed therein, and a cathode 130 formed on the integrated stack 120.

The support 110, which is formed in a flat plate shape and serves to support the integrated stack 120, contains the metal. More specifically, the support 110 is made of the metal having a porous metal form or a mesh structure, such that fuel may be transferred to the anode 123 through the support 110. Here, the porous metal foam may be made of Ni and doped zirconia cement, Ni doped –CeO₂ cement, Cu doped-ceria cement, silver-(Bi—Sr—Ca—Cu—O)-oxide cement, silver-(Y—Ba—Cu—O)-oxide cement; silver-alloy-(Bi—Sr—Ca—Cu—O)-oxide cement; silver-alloy-(Y—Ba—Cu—O)-oxide cement; silver and its alloys, Inconel steel and any hard metal alloy, ferritic steel, SiC, MoSi₂, or the like, but is not limited thereto. That is, any metal foam may be used as long as the metal foam has electrical conductivity. Meanwhile, the support 110 may be adhered to the integrated stack 120 using a chemical binder 140. As described above, the support 110 and the integrated stack 120 are adhered to each other using the chemical binder 140 after being separately manufactured, such that the support 110 and the integrated stack 120 needs not to be co-sintered with each other. Therefore, it may be prevented that the support 110 containing the metal is oxidized to deteriorate performance of the fuel cell 100 while reducing electrical conductivity. However, since the support 110 and the integrated stack 120 are adhered to each other using the chemical binder 140, in the case in which the support 110 and the integrated stack 120 having different thermal expansion coefficients from each other are expanded in different ratios, contact between the surface of the support 110 and the integrated stack 120 may not be maintained, such that contact resistance therebetween may be increased. However, since the surface 115 contacting the integrated stack 120 is corrugated, the support 110 of the fuel cell 100 according to the preferred embodiment of the present invention has high thermal flexibility, even though the support 110 and the integrated stack 120 having different thermal expansion coefficients from each other are expanded in different ratios, the contact between the surface of the support 110 and the integrated stack 120 may be maintained. Therefore, it may be prevented that the contact resistance between the support 110 and the integrated stack 120 is increased. Meanwhile, the opposite surface 117 of the support 110 as well as the surface 115 contacting the integrated stack 120 may also be formed to be corrugated, such that contact resistance between the support 110 and a manifold, or the like, may be minimized.

The integrated stack 120 includes the anode 123 and the electrolyte 125, wherein the anode 123 and the electrolyte 125 are sequentially stacked on the support 110 in a flat plate shape. Here, the anode 123 receives the fuel such as hydrogen, or the like, through the support 110 to serve as an anode through an electrode reaction. In this case, the anode 123 is made of nickel oxide (NiO) and yttria stabilized zirconia (YSZ), wherein nickel oxide (NiO) is reduced to metallic nickel by hydrogen to exhibit electron conductivity, and yttria stabilized zirconia (YSZ) exhibits ion conductivity as oxide. In addition, the electrolyte 125 serves to transfer oxygen ions generated in the cathode 130 to the anode 123. Here, the electrolyte 125 may be made of yttria stabilized zirconia (YSZ) or scandium stabilized zirconia (ScSZ), gadolinia-doped ceria (GDC), La₂O₃-Doped CeO₂ (LCD), or the like. Here, since tetravalent zirconium ions are partially substituted with trivalent yttrium ions in the yttria stabilized zirconia, one oxygen hole per two yttrium ions is generated therein, and oxygen ions move through the hole at a high temperature. In addition, when pores are generated in the electrolyte 125, since a crossover phenomenon of directly reacting fuel with oxygen (air) may be generated to reduce efficiency, it needs to be noted so that a scratch is not generated.

Meanwhile, the integrated stack 120 may further include a prevention film 127 formed on the electrolyte 125. Here, the prevention film 127 serves to prevent a secondary phase from being generated by chemical reactions between the electrolyte 125 and the cathode 130. Here, the preventing membrane 127 needs to be dense, have high conductivity, hardly react with the electrolyte 125. Considering this point, the prevention film 127 is not particularly limited but may be made of GDC.

In addition, the anode 123, the electrolyte 125, and the prevention film 127 configuring the integrated stack 120 may be manufactured in a sheet shape by a tape-casting method. As described above, since the anode 123, the electrolyte 125, and the prevention film 127 are co-sintered after they are manufactured in the sheet shape and stacked, a sintering process may be minimized, such that generation of the secondary phase on the interfaces of the anode 123, the electrolyte 125, and the cathode 130 may be minimized.

The cathode 130 receives oxygen, air, or the like, to serve as a cathode through an electrode reaction. Here, the cathode 130 may be made of lanthanum strontium cobalt ferrite (LSCF) having high electron conductivity, or the like. In the cathode 130 described above, oxygen is converted into oxygen ion by a catalytic reaction of LSCF to thereby be transferred to the anode 123 through the electrolyte 125. Meanwhile, the cathode 130 may be formed on the integrated stack 120 by a spray-coating method, a screen-printing method, or the like.

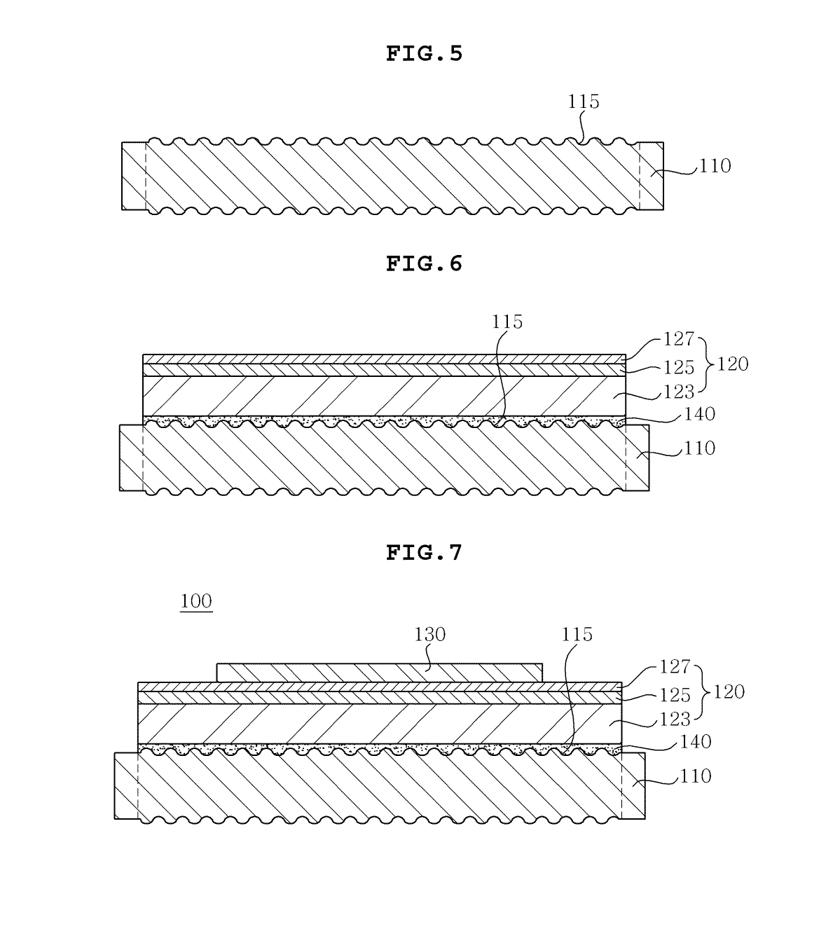

FIGS. 2 to 7 are cross-sectional views showing a method of manufacturing a fuel cell according to the preferred embodiment of the present invention in a process sequence.

As shown in FIGS. 2 to 7, the method of manufacturing a fuel cell 100 according to the preferred embodiment of the present invention includes (A) forming an integrated stack 120 having an anode 123 and an electrolyte 125 sequentially stacked, (B) preparing a support 110 having a corrugated surface 115 and containing a metal, (C) adhering the integrated stack 120 to the surface 115 of the support 110, and (D) forming a cathode 130 on the integrated stack 120.

First, as shown in FIGS. 2 to 4, the forming of the integrated stack 120 is performed. Here, the integrated stack 120 may be formed so that the anode 123 and the electrolyte 125 are sequentially stacked, and a prevention film 127 may further be formed on the electrolyte 125.

More specifically, after the anode 123 is formed as shown in FIG. 2, the electrolyte 125 is formed thereon as shown in FIG. 3. Here, the anode 123 and the electrolyte 125 may be formed in sheet shape by a tape-casting method.

Then, as shown in FIG. 4, the prevention film 127 may be formed on the electrolyte 125. Here, the prevention film 127, which serves to prevent the secondary phase from being generated by a chemical reaction between the electrolyte 125 and the cathode 130, may be formed in a sheet shape by the tape casting method.

As described above, since the anode 123, the electrolyte 125, and the prevention film 127 are formed in the sheet shape and sintered simultaneously with each other through co-sintering, such that the sintering process may be minimized Therefore, the method for a fuel cell 100 according to the present embodiment may simplify a manufacturing process and reduce manufacturing cost, and generation of the secondary phase on the interface may be minimized Meanwhile, in the forming of the prevention film 127, GDC powder particles forming the prevention film 127 are atomized at a size of 100 nm or more, such that excellent dispersibility may be implemented by high viscosity process. In addition, 0.1% or more of aluminum is added to YSZ and GDC forming the anode 123, the electrolyte 125, and the prevention film 127 as a sintering promoter, such that excellent dispersibility may be implemented using high viscous slurry.

Next, as shown in FIG. 5, the preparing of the support 110 is performed. Here, the support 110 contains a metal, and more particularly, may be made of porous metal foam or a metal having a mesh structure. In addition, in order to prevent contact resistance with the integrated stack 120 to be adhered in the following process from being increased, the surface 115 of the support 110 may be formed to be corrugated. Meanwhile, a method of forming the support 110 is not particularly limited, but may be performed using a rolling machine.

Then, as shown in FIG. 6, the adhering of the integrated stack 120 to the surface 115 of the support 110 is performed. Here, the support 110 and the integrated stack 120 may be adhered to each other using a chemical binder 140. More specifically, a process of adhering the support 110 and the integrated stack 120 to each other may be performed by thermal treatment at a temperature of 600 or less for 3 hours or more under H₂ and N₂ gas atmosphere after the support 110 and the integrated stack 120 are coated with the chemical binder 140. As described above, the support 110 and the integrated stack 120 are adhered to each other using the chemical binder 140 after being separately manufactured, such that the support 110 and the integrated stack 120 needs not to be co-sintered with each other. Therefore, it may be prevented that the support 110 containing the metal is oxidized to deteriorate performance of the fuel cell 100. However, since the support 110 and the integrated stack 120 are adhered to each other using the chemical binder 140, contact resistance between the support 110 and the integrated stack 120 may be increased. However, according to the present invention, since the surface 115 of the support 110 is corrugated, thermal flexibility is increased, thereby making it possible to prevent a problem that contact resistance with the integrated stack 120 is increased in advance.

Then, as shown in FIG. 7, the forming of the cathode 130 is performed. Here, the cathode 130 may be formed by a spray coating method or a screen printing method. The cathode 130 is formed as described above, such that the anode 123, the electrolyte 125 and the cathode 130 configure a unit cell, thereby making it possible to generate electric energy.

As set forth above, according to the embodiments of the present invention, since the anode, the electrolyte, and the like, are manufactured in a high viscous sheet shape to thereby be adhered to the support, the sintering process may be minimized, such that the manufacturing process may be simplified and the manufacturing cost may be reduced.

In addition, according to the embodiments of the present invention, the sintering process is minimized, such that generation of the secondary phase at the interface of the anode, the electrode, and the cathode may be minimized.

Further, according to the embodiments of the present invention, since the integrated stack (the anode and the electrolyte) is not co-sintered with the support, it may be prevented that the support containing the metal is oxidized to deteriorate performance of the fuel cell while reducing electrical conductivity.

Furthermore, according to the embodiments of the present invention, even though the support and the integrated stack are thermally expanded at different ratios, since the corrugated surface of the support maintain contact with the integrated stack, it may be prevented that the contact resistance between the support and the integrated stack is increased.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A fuel cell comprising:
a support having a corrugated surface and containing a metal;
an integrated stack adhered to the surface of the support and including an anode and an electrolyte sequentially formed therein; and
a cathode formed on the integrated stack.

2. The fuel cell as set forth in claim 1, wherein the integrated stack further includes a prevention film formed on the electrolyte.

3. The fuel cell as set forth in claim 1, wherein the support and the integrated stack are adhered to each other using a chemical binder.

4. The fuel cell as set forth in claim 1, wherein the support is made of porous metal foam or a metal having a mesh structure.

5. The fuel cell as set forth in claim 1, wherein the anode and the electrolyte are manufactured in a sheet shape by a tape casting method.

6. The fuel cell as set forth in claim 1, wherein the cathode is formed by a spray coating method or a screen printing method.

7. The fuel cell as set forth in claim 2, wherein the prevention film is manufactured in a sheet shape by a tape casting method.
